(19) United States
(12) Patent Application Publication
(10) Pub. No.: US 2011/0165362 A1
(43) Pub. Date: Jul. 7, 2011

(54) METHOD AND FORMAT FOR STICKERS AND LABELS

(76) Inventors: Ronald F. DeSanto, JR., Darien, IL (US); Norma D. Kammerer, Bloomingdale, IL (US)

(21) Appl. No.: 12/984,257

(22) Filed: Jan. 4, 2011

Related U.S. Application Data
(60) Provisional application No. 61/292,030, filed on Jan. 4, 2010.

(51) Int. Cl. B32B 7/06; B32B 7/10; C09J 7/02; B32B 37/00

(52) U.S. Cl. 428/42.3; 428/43; 156/182

(57) ABSTRACT

A format for stickers and labels comprises a first ply having an inner side and a UV pressure-sensitive adhesive applied to the inner side of the second ply, the adhesive being cured, a second ply having an inner side, the inner side of said second ply being married to the inner side of the first ply, and a kiss cut formed in at least one of said first ply and said second ply.

### PRIORITY

This application claims priority from U.S. Provisional Patent Application No. 61/292,030, filed Jan. 4, 2010, the disclosure of which is incorporated herein.

### BACKGROUND OF THE INVENTION

The invention relates to the field of printing and in particular to printing material with removable items. Removable items include stickers and dry peel cards. The term “removable items” as used herein, however, is not limited to items that are completely removable from the substrate. Some removable items peel partially away from the substrate but remain attached.

A sticker is generally applied to a substrate using a wet adhesive. A sticker in most cases is meant to be removed from the substrate and then re-applied to another material. Examples include stickers used as temporary identification badges at trade shows or as building passes, or good-behavior stickers given to children by a dentist. Stickers are generally not meant to be used again; once a visitor leaves a building and removes his or her building pass, it is disposed of and not re-applied.

A prior-art sticker format 20 is shown in diagrammatic, non-scale cross-section in FIG. 1. Sticker format 20 comprises a substrate 22, a wet adhesive 24, and sticker ply 26. Usually, sticker format 20 is kiss-cut through the layer of sticker ply 26 only, so a sticker can be peeled off substrate 22. Some of wet adhesive 24 remains on the sticker for adherence to, for example, the shirt of a well-behaved dental patient.

A dry peel card, on the other hand, is applied to a substrate using a dry adhesive. Once the dry peel card has been removed from the substrate, it is not meant to be re-applied to anything. Accordingly, it is preferable that no tacky adhesive remain. A dry peel card ideally should remove cleanly, leaving no trace of adhesive on the card. However, should any adhesive remain, it is usually better for the remnants to stay on the substrate, rather than on the dry peel card.

In the prior art, a dry peel card had an ultraviolet release coating on the adhesion side of the card. The substrate was coated with a dry adhesive to adhere the dry peel card to the substrate. The purpose of the UV release coating was to provide a protective barrier to limit the adhesion between the dry adhesive and the dry peel card, so the dry peel card was easily removable without damage and without residual adhesive.

Dry peel cards, in particular, need not be completely removable from the substrate. For example, an advertisement in a mass mailing or in a magazine may have a dry peel card that peels partially away from a substrate to expose further printed material underneath. This type of dry peel card may be rectangular and is kiss-cut on three sides, so that when it is peeled away from the substrate, it remains attached on the fourth side.

A prior-art dry-peel format 30 is shown in diagrammatic, non-scale cross-section in FIG. 2. Dry-peel format 20 comprises a substrate 32, a dry adhesive 34, a UV release coating 36, and dry-peel card ply 38. Usually, dry-peel format 30 is kiss-cut through the layers of dry-peel card ply 38 and UV release coating 36 only, so a dry-peel card can be peeled off substrate 32.

In the prior art, both sticker format 20 and dry-peel format 30 could be manufactured by an in-line process, on, for example, a web press. In that instance, sticker format 20 can be formed by marrying ribbons slit from the web or by folding a single ribbon onto itself, in which case substrate 22 and sticker ply 26 are formed from the same web. Similarly, dry-peel format 30 can be formed by marrying ribbons slit from the web or by folding a single ribbon onto itself, in which case substrate 32 and dry-peel card ply 38 are formed from the same web.

In some cases, advertisers want to provide scent to accompany advertising materials. In the prior art, microencapsulated fragrances were applied to items such as mass mailings and magazine advertisements. The microencapsulated fragrances are held between flaps of paper so that when the flap is opened, the microcapsules burst, causing the fragrance to bloom.

### BRIEF SUMMARY OF THE INVENTION

The present invention provides a format by which a substrate such as a web is slit into a first ribbon and a second ribbon, a UV pressure-sensitive adhesive is applied to the second ribbon, the UV pressure-sensitive adhesive is cured, and the first ribbon is married to the UV pressure-sensitive adhesive side of the second ribbon, creating a married ribbon with a first ply and a second ply. The married ribbon is kiss cut. If the kiss-cut is performed on the first ribbon side, a sticker is created. If the kiss-cut is applied on the second ribbon side, a dry peel card is created.

The present invention further encompasses the use of fragrance oils in the UV pressure-sensitive adhesive.

### BRIEF DESCRIPTION OF THE SEVERAL VIEWS OF THE DRAWINGS

The organization and manner of the structure and operation of the invention, together with further objects and advantages thereof, may best be understood by reference to the following description, taken in connection with the accompanying non-scale drawings, wherein like reference numerals identify like elements in which:

FIG. 1 is a diagrammatic, cross-sectional view of a sticker format as known in the prior art.

FIG. 2 is a diagrammatic, cross-sectional view of a dry-peel format as known in the prior art.

FIG. 3 is a diagrammatic, cross-sectional view of the format of the preferred embodiment of the present invention.

FIG. 4 is the format of FIG. 3 with kiss cuts forming a dry-peel card.

FIG. 5 is the format of FIG. 3 with kiss cuts forming a sticker.

FIG. 6 is a diagrammatic elevation view of the preferred embodiment of the system for manufacturing the preferred embodiment of the format of the present invention.

FIG. 7 is a diagrammatic elevation view of another embodiment of the system for manufacturing the preferred embodiment of the format of the present invention.

FIG. 8 is a plan view of a ribbon slit from a web in the embodiment of FIG. 7.

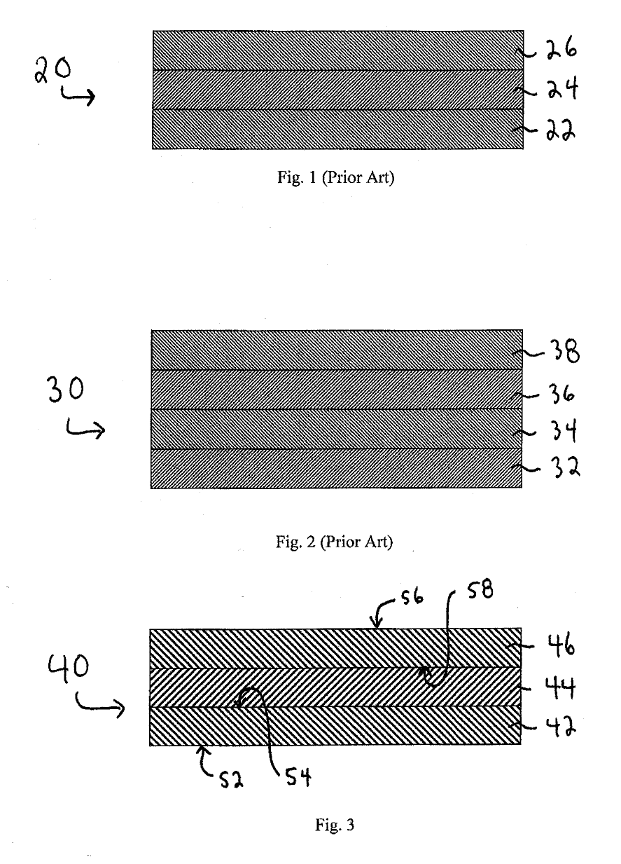

### DETAILED DESCRIPTION OF THE INVENTION

While the invention may be susceptible to embodiment in different forms, there is shown in the drawings, and herein will be described in detail, specific embodiments with the understanding that the present disclosure is to be considered an exemplification of the principles of the invention, and is not intended to limit the invention to that as illustrated and described herein.

The format 40 of the preferred embodiment of the present invention is shown in diagrammatic, non-scale cross-section in FIG. 3. Format 30 comprises a first ply 42, a UV-pressure sensitive adhesive 44, and a second ply 46. First ply 42 has an outer side 52 and an inner side 54. Second ply 46 has an outer side 56 and an inner side 58. UV-pressure sensitive adhesive 44 is applied to inner side 58 of second ply 46 and is cured. First ply 42 and second ply 46 are married, with inner side 52 facing inner side 54, to form format 40.

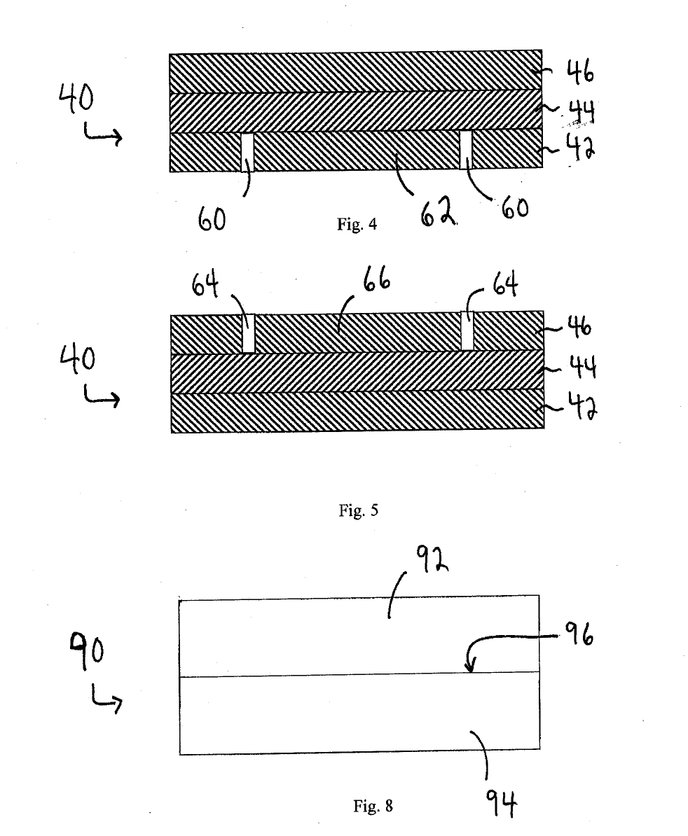

Format 40 can be used to manufacture either dry-peel cards or stickers. In a first aspect of the preferred embodiment of the invention, kiss-cuts 60 are formed in first ply 42, as shown in FIG. 4. The portion of first ply 42 between kiss-cuts 60 is a dry peel card 62. In a second aspect of the preferred embodiment of the invention, kiss-cuts 64 are formed in second ply 46, as shown in FIG. 5. The portion of second ply 46 between kiss-cuts 64 is sticker 66.

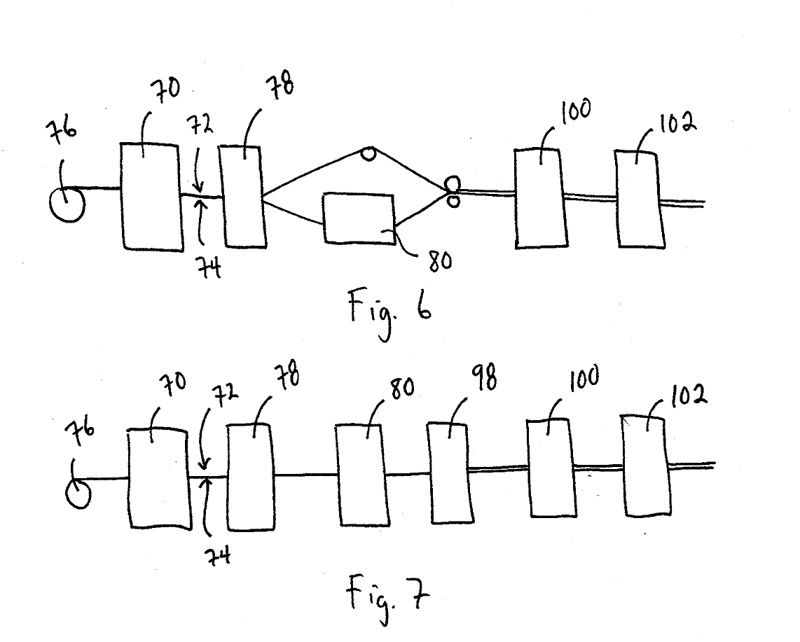

The preferred embodiment of manufacture of format 40 is on a conventional web press 70, as shown in diagrammatic elevation view in FIG. 6. Web press 70 prints on one or both sides 72, 74 of web 76. In one aspect of this embodiment of the invention, web 76 is slit into a plurality of ribbons by slitter 78, including first ply 42 and second ply 46. An applicator 80 applies UV pressure-sensitive adhesive 44 to inner side 58 of second play 46. Second play 46 is then exposed to ultraviolet light in applicator 80 to cure UV pressure-sensitive adhesive 44. First ply 42 is then married to second ply 46, with inner side 54 of first ply 42 facing inner side 58 of second ply 46, to form format 40.

In another aspect of the preferred embodiment of the invention, format 40 is manufactured on a conventional web press 70, as shown in diagrammatic elevation view in FIG. 7. Web 76 is slit into a plurality of ribbons by slitter 78, including folding ribbon 90, shown in plan view in FIG. 8. Folding ribbon 90 is divided longitudinally into a left half 92 and a right half 94 by fold line 96. Applicator 80 applies UV pressure-sensitive adhesive 44 to right half 94. Right half 64 is then exposed to ultraviolet light in applicator 80 to cure UV pressure-sensitive adhesive 44. Folding ribbon 90 is then folded onto itself at fold line 96 by plow 98, so that left half 92 faces right half 94, to form format 40. The portion of folding ribbon 90 with left half 92 becomes first ply 42 and the portion of folding ribbon 90 with right half 94 becomes second ply 46.

Under either aspect of the preferred embodiment of the present invention, format 40 then proceeds to kiss cutter 100. To make dry-peel card 62, kiss cutter 100 makes kiss cuts 60 in first ply 46. To make sticker 66, kiss cutter 100 makes kiss cuts 64 in second ply 42. If desired, kiss cutter 100 can make both kiss cuts 60 and kiss cuts 64 in different portions of format 40, so that one side has stickers 66 and the opposite side has dry-peel cards 62.

Once dry-peel cards 62 and/or stickers 82 have been formed in format 40, format 40 proceeds to finishing station 102, where it is finished in a conventional manner. Format 40 can be laterally cut and married to other ribbons of web 76, which are slit, folded, glued, and cut in a variety of ways known in the art, to create any number of variations of insert pieces, each of which contain one or more dry-peel card 62 or sticker 66.

Finishing operations include but are not limited to forming mass-distributable packets, inserts for magazines, and individual sheets. Other operations that can be performed on format 40, or on any ribbon cut from web 76, include but are not limited to application of aqueous coating, overall and spot UV coatings, film lamination, embossing, foil and hologram stamping, and post embossing.

The method of the one embodiment of the present invention is:

Step 201. Print a web.

Step 202. Slit the web into a plurality of ribbons, including at least a first ribbon and a second ribbon.

Step 203. Apply UV pressure-sensitive adhesive to second ribbon.

Step 204. Expose UV pressure-sensitive adhesive to ultraviolet light.

Step 205. Marry first ribbon to second ribbon.

Step 206. Kiss cut at least one of first ribbon and second ribbon.

Step 207. Finishing operations.

The method of another embodiment of the present invention is:

Step 208. Print a web.

Step 209. Slit the web into a plurality of ribbons, including at least a folding ribbon.

Step 210. Apply UV pressure-sensitive adhesive to one-half of the folding ribbon.

Step 211. Expose UV pressure-sensitive adhesive to ultraviolet light.

Step 212. Fold folding ribbon onto itself.

Step 213. Kiss cut one side or the other of the folded ribbon.

Step 214. Finishing operations.

The invention can also be used in operations other than web-based printing, such as single sheet or single page printing.

The inventors have found that, surprisingly, the application of UV pressure-sensitive adhesive 44 to one ribbon, followed by cure of that material and marrying of another ribbon (or folding over of the same ribbon), creates a format that can become either dry-peel card 62 or sticker 66. UV pressure-sensitive 44 will remain on the play to which it was applied and cured. Accordingly, one side of the format can become a sticker and the other side can become a dry-peel card.

In one embodiment of the invention, UV pressure-sensitive adhesive 44 preferably comprises the following materials, mixed well, preferably in the following proportions:

| | |
|---|---|
| UV Rosin-Monomer Blend (preferably UFO-349) | 63.5 LB |
| Acrylated Urethane Polyol (preferably Ebecryl 230) | 25.0 LB |
| TPDGA Tripropylene Glycol Diacrylate (preferably Etermer- | 2.0 LB |
| 223) | |
| UV Flexo Photoinitiator (preferably UFO-279) | 7.5 LB |
| 75% Surfynol 104/IPA Solution (preferably UFO-325) | 0.75 LB |
| Wetting Agent 50% (preferably LA-A 1070) | 0.25 LB |
| Slip Additive and Deaerator (preferably Tego Rad 2500) | 1.0 LB |

The UV Rosin-Monomer Blend preferably comprises the following materials, mixed well until clear, preferably in the following proportions:

| | |
|---|---|
| 18WR40Semi-Solid Stabilized Rosin Ester (preferably | 30.0 LB |
| Sylvatac Re40) | |
| Monofunctional Aromatic Acrylate (preferably Photomer-4003) | 69.8 LB |
| Inhibitor Compound Blend (preferably Omnistab IN-516) | 0.2 LB |

The UV Rosin-Monomer Blend should be heated to 140 F before mixed to make the UV pressure-sensitive adhesive.

In another embodiment of the invention, UV pressure-sensitive adhesive 44 contains fragrance oil. The inventors have found, surprisingly, that the following formulation blends well with fragrance oils, avoiding the need for microencapsulated fragrances. The use of UV pressure-sensitive adhesive 44 on folds and flaps of printed materials, or on stickers 66 and dry peel cards 62, allows the fragrance to bloom upon opening the fold or flap or upon removal of the sticker 66 or dry peel card 62.

This embodiment of the present invention preferably comprises the following materials, mixed well, preferably in the following proportions:

| | |
|---|---|
| UV Low Odor Rosin Varnish (preferably UFO-403) | 56.0 LB |
| Acrylated Urethane Polyol (preferably Ebecryl 230) | 17.5 LB |
| TPDGA Tripropylene Glycol Diacrylate (preferably | 1.75 LB |
| Etermer-223) | |
| Urethane Acrylate Oligomer (preferably Ebecryl 220) | 3.5 LB |
| Multifunctional Triacrylate Monomer (preferably Etermer 231) | 2.75 LB |
| UV Low Odor Photoinitiator (preferably UFO-348) | 6.5 LB |
| 75% Surfynol 104/IPA Solution (preferably UFO-UFO-325) | 0.75 LB |
| Wetting Agent 50% (preferably LA-A 1070) | 0.25 LB |
| Slip Additive and Deaerator (preferably Tego Rad 2500) | 1.0 LB |
| W.S. Cinnamon Fragrance ORC0600682 (preferably RCX-7001) | 10.0 LB |

The UV Low Odor Rosin Varnish of this embodiment preferably comprises the following materials, preferably in the following proportions:

| | |
|---|---|
| Stabilized Rosin Ester (preferably Sylvatac Re 85) | 30.0 LB |
| Monofunctional Aromatic Acrylate (preferably Photomer-4003) | 69.8 LB |
| Inhibitor Compound Blend (preferably Omnistab IN-516) | 0.2 LB |

The UV Low Odor Rosin Varnish is preferably made by heating these materials to 185 F until dissolved, then cooling to room temperature.

The UV Low Odor Photoinitiator of this embodiment preferably comprises the following materials, preferably in the following proportions:

| | |
|---|---|
| Acrylated Benzophenone (preferably Ebercryl P36) | 1.00 lb |
| Diphenyl (2,4,6-Trimethylbenzoyl (preferably Aalchem PI- | 0.27 lb |
| TPO) | |
| Acrylated Amine (preferably Etermen 6420) | 0.50 lb |
| Photo-Initiator 907 (preferably Aalchem PI-907) | 0.27 lb |
| Photo-Initiator 184 (preferably Irgacure 184 or Aalchem PI- | 0.378 lb |
| 184) | |
| Photo Initiator (preferably Eterphoto-PI1173) | 0.162 lb |

The UV Low Odor Photoinitiator is preferably made by mixing these materials to 200 F until fully dissolved.

Other fragrances besides cinnamon can be used.

In order to use fragrances, it is advantageous to minimize the heat applied to the web, in order not to burn the fragrance oil. The inventors have found that satisfactory curing of the UV pressure-sensitive adhesive was achieved using 15 percent power of a 2,000 Watt ultraviolet light, without unduly heating the web.

While preferred embodiments of the present invention are shown and described, it is envisioned that those skilled in the art may devise various modifications of the present invention without departing from the spirit and scope of the appended claims.

We claim:

1. A format for stickers and labels, comprising:
a first ply having an inner side;
a UV pressure-sensitive adhesive applied to the inner side of the first ply, the adhesive being exposed to ultraviolet light;
a second ply having an inner side, the inner side of said second ply being married to the inner side of the first ply; and
a kiss cut formed in at least one of said first ply and said second ply.

2. The format of claim 1, wherein the adhesive comprises fragrance oil.

3. A method of manufacturing a format for stickers and labels, comprising the steps of:
printing a substrate;
slitting the substrate into a plurality of ribbons, including at least a first ribbon and a second ribbon;
applying UV pressure-sensitive adhesive to a first side of the second ribbon;
exposing the adhesive to ultraviolet light;
marrying the first ribbon to the first side of the second ribbon;
kiss cutting at least one of the first ribbon and the second ribbon.

4. The method of claim 3, further comprising conducting finishing operations on at least one of the ribbons.

5. The method of claim 3, wherein the substrate comprises a web.

6. The method of claim 3, wherein the adhesive comprises a fragrance oil.

7. A method of manufacturing a format for stickers and labels, comprising the steps of:
printing a substrate, the substrate having a top side and a bottom side, the top side having a left half and a right half;
applying UV pressure-sensitive adhesive to one of the left half and the right half;
exposing the adhesive to ultraviolet light;
folding the substrate itself to marry the left half to the right half to form a two-ply substrate;
kiss cutting at least one of the first ply and the second ply of the two-ply substrate.

8. The method of claim 7, further comprising conducting finishing operations on at least one of the ribbons.

9. The method of claim 7, wherein the substrate comprises a ribbon slit from a web.

10. The method of claim 7, wherein the adhesive comprises a fragrance oil.
